(19) United States
(12) Patent Application Publication
(10) Pub. No.: US 2026/0183754 A1
(43) Pub. Date: Jul. 2, 2026

(54) PREPARATION METHOD OF HIGH-EFFICIENCY PHOTOCATALYST FOR PHOTOCATALYTIC DEGRADATION OF TETRACYCLINE FROM ELECTRIC ARC FURNACE DUST (EAFD)

(71) Applicant: Yunnan Minzu University, Kunming (CN)

(72) Inventors: Lijuan JIA, Kunming (CN); Shuo CUI, Kunming (CN); Guoxin MU, Kunming (CN); Jiayu FENG, Kunming (CN); Fang WANG, Kunming (CN); Rui CAO, Kunming (CN); Zibin PAN, Kunming (CN); Ping NING, Kunming (CN); Yonghui LI, Kunming (CN); Yanzhang LIU, Kunming (CN)

(73) Assignee: Yunnan Minzu University, Kunming (CN)

(21) Appl. No.: 19/433,299

(22) Filed: Dec. 26, 2025

(30) Foreign Application Priority Data
Dec. 26, 2024 (CN) 202411938594.0

(51) Int. Cl. B01J 23/80; B01J 35/39; B01J 37/00; B01J 37/04; B01J 37/06; B01J 37/08; B01J 37/34; C02F 1/30; C02F 1/44; C02F 1/72; C02F 101/34; C02F 101/38

(52) U.S. Cl. CPC B01J 23/80; B01J 35/39; B01J 37/009; B01J 37/04; B01J 37/06; B01J 37/08; B01J 37/343; C02F 1/30; C02F 1/444; C02F 1/725; C02F 2101/345; C02F 2101/38; C02F 2305/10

(57) ABSTRACT

A preparation method of a high-efficiency photocatalyst for photocatalytic degradation of tetracycline from electric arc furnace dust (EAFD) is provided, belonging to the technical field of solid waste resource utilization and water pollution control. The method includes: step 1: collecting EAFD from a steel plant or other industrial processes; mixing the EAFD with deionized water for ultrasonic washing to remove surface impurities and soluble salts; conducting filtration; and pouring an obtained filtered product into an oven, and drying at 80° C. to 100° C. for 3 h to 10 h to obtain solid EAFD. This method enables the high-value utilization of solid waste generated by the steel industry, reducing issues such as resource waste and environmental pollution. A material obtained after calcination exhibits superior separation capability of photogenerated electrons and holes, thereby possessing excellent photocatalytic activity and showing promising application prospects in the field of environmental purification.

### CROSS REFERENCE TO RELATED APPLICATION

This patent application claims the benefit and priority of Chinese Patent Application No. 2024119385940, filed with the China National Intellectual Property Administration on Dec. 26, 2024, the disclosure of which is incorporated by reference herein in its entirety as part of the present application.

### TECHNICAL FIELD

The present disclosure relates to the technical field of solid waste resource utilization and water pollution control, specifically to a preparation method of a high-efficiency photocatalyst for photocatalytic degradation of tetracycline from electric arc furnace dust (EAFD).

### BACKGROUND

With the acceleration of industrialization and the continuous development of human activities, a large amount of organic pollutants are discharged into water bodies, seriously threatening ecological balance and human health. The discharge of emerging pollutants has become a significant challenge for global environmental protection. Pharmaceuticals and personal care products (PPCPs) have emerged as a new class of contaminants, posing serious threats to human health. Antibiotics are one of the main components of PPCPs. Industrial processes involved in antibiotic production may lead to the release of these compounds into water bodies via wastewater discharge. The concentration of antibiotics in surface water, wastewater, and even drinking water has far exceeded regulatory standards.

Tetracycline (TC), a well-known broad-spectrum antibacterial agent among antibiotics, is widely used to treat bacterial infections in humans and livestock. However, due to the misuse of antibiotics and the high chemical stability of the drugs themselves, tetracycline is difficult to be metabolized biologically by humans and animals. When discharged into water bodies, TC molecules accumulate extensively in aquatic environments, thereby causing serious impacts on ecosystems and public health. To address this issue, various technologies have been developed to remove and degrade TC in water, such as biodegradation, physical adsorption, and advanced oxidation processes (AOPs). As a type of AOPs, photocatalytic treatment is a novel green process route. Due to the advantages of high efficiency, sustainability, stability, and low cost, photocatalytic treatment is considered a promising strategy for treating TC-containing wastewater.

Electric arc furnace dust (EAFD), a by-product of the steel industry, is a solid waste that can impose a burden on the environment if not handled properly. Currently, most EAFD is disposed of in landfills, which may have significant environmental impacts. Therefore, converting EAFD into useful materials is considered a crucial approach to addressing these issues. Recent research has found that EAFD possesses unique physical and chemical properties, making it a potential high-efficiency photocatalyst for the photocatalytic degradation of organic pollutants in water. EAFD primarily contains iron and zinc. Iron mainly exists in the forms of magnetite (Fe₃O₄) and zinc ferrite (ZnFe₂O₄), while zinc exists as zincite (ZnO) and zinc ferrite (ZnFe₂O₄). Among these, ZnFe₂O₄ and ZnO are common photocatalytic materials for wastewater purification. Heterojunction photocatalytic materials have been demonstrated to exhibit excellent photocatalytic activity under visible light irradiation. Currently, extensive research focuses on synthesizing such photocatalytic materials using chemical synthesis methods. However, the photocatalytic activity of these materials is generally limited by their bandgap energy, such that they are rarely used as photocatalysts in single-phase forms. Furthermore, photocatalysts synthesized by various methods suffer from issues such as high preparation costs and complicated processes. Utilizing the low-cost solid waste material EAFD to prepare heterojunction photocatalytic materials for wastewater treatment, achieving the goal of treating waste with waste, holds great application prospects.

Therefore, the present disclosure is proposed to solve the aforementioned problems by providing a preparation method of a high-efficiency photocatalyst for photocatalytic degradation of tetracycline from EAFD.

### SUMMARY

An objective of the present disclosure is to provide a preparation method of a high-efficiency photocatalyst for photocatalytic degradation of tetracycline from electric arc furnace dust (EAFD), so as to solve the problems mentioned in the background.

To achieve the above objective, the present disclosure provides the following technical solutions. The present disclosure provides a preparation method of a high-efficiency photocatalyst for photocatalytic degradation of tetracycline from EAFD, including the following steps:
step 1: collecting EAFD from a steel plant or other industrial processes; mixing the EAFD with deionized water for ultrasonic washing to remove surface impurities and soluble salts; conducting filtration; and pouring an obtained filtered product into an oven, and drying at 80° C. to 100° C. for 3 h to 10 h to obtain solid EAFD;
step 2: mixing the solid EAFD obtained in the step 1 with an acid solution, stirring for 1 h to 2 h to remove a part of surface metal oxides and other impurities; and washing with deionized water until neutral, and drying to obtain treated solid EAFD;
step 3: mixing the treated solid EAFD obtained in the step 2 with an alkali solution, stirring for 1.5 h to 2 h to further modify a surface structure; and washing with deionized water until neutral, and drying to obtain modified solid EAFD;
step 4: subjecting the modified solid EAFD to a heat treatment at a high temperature, namely placing the modified solid EAFD into a tubular furnace, introducing O₂ as a carrier gas, and heating to a temperature of 400° C. to 900° C. at a heating rate of 10° C./min and holding the temperature for 2 h; and cooling to room temperature at a cooling rate of 10° C./min to obtain a photocatalyst ZnFe₂O₄@ZnO; and
step 5: adding the photocatalyst ZnFe₂O₄@ZnO to a tetracycline solution with a concentration of 30 mg/L, where a dosage of the ZnFe₂O₄@ZnO is 0.1 g/L; after stirring in the dark for 30 min to achieve an adsorption equilibrium, initiating degradation using a 300 W rare-element lamp as a simulated light source; withdrawing an equal volume of an obtained reaction solution at a time interval of 1 h to 2 h, filtering the reaction solution through a 0.22 μm microporous membrane, transferring an obtained filtrate into a 2 mL high-performance liquid chromatography (HPLC) vial, and observing color and concentration changes of the filtrate.

Preferably, the EAFD and the deionized water are mixed at a solid-to-liquid ratio of 1 g:
80 mL in the step 1.

Preferably, when detecting a degradation effect of the tetracycline, HPLC is conducted to determine a concentration (Ct) of the tetracycline; and an initial concentration of the tetracycline is recorded as C₀, and Cₜ/C₀ represents a ratio of a remaining amount of the tetracycline after the degradation.

Preferably, the rare-element lamp in the step 5 includes a xenon lamp and a mercury lamp.

Preferably, the acid solution in the step 2 is selected from the group consisting of dilute sulfuric acid and nitric acid.

Preferably, the alkali solution in the step 3 is a sodium hydroxide solution.

Compared with the prior art, beneficial effects of the present disclosure are as follows:
1) In the present disclosure, the method enables the high-value utilization of solid waste generated from the steel industry, reducing problems such as resource waste and environmental pollution.
2) A material obtained after calcination exhibits superior separation capability of photogenerated electrons and holes, thereby possessing excellent photocatalytic activity and demonstrating promising application prospects in the field of environmental purification. When used as a photocatalytic material for treating antibiotic-containing wastewater, the photocatalyst can efficiently remove tetracycline from the wastewater. This offers advantages such as simple operation, low cost, and high removal efficiency, meeting the requirements for practical applications.
3) The prepared material exhibits magnetic recoverability, which addresses the challenge in recovery and reuse of photocatalysts, showing excellent application potential.

### BRIEF DESCRIPTION OF THE DRAWINGS

FIG. 1 shows the X-ray diffraction (XRD) patterns of the phase composition of EAFD before and after water washing;

FIG. 2 shows the XRD patterns of EAFD calcined at different temperatures;

FIG. 3 shows the tetracycline degradation performance diagram of EAFD; and

FIG. 4 shows a comparative diagram of the tetracycline degradation performance of EAFD calcined at different temperatures.

### DETAILED DESCRIPTION OF THE EMBODIMENTS

The technical solutions of the examples of the present disclosure are clearly and completely described below with reference to the drawings. Apparently, the described examples are merely a part rather than all of the examples of the present disclosure. All other examples obtained by those skilled in the art based on the examples of the present disclosure without creative efforts shall fall within the protection scope of the present disclosure.

In the description of the present disclosure, it should be understood that orientation or position relationships indicated by terms such as “upper,” “lower,” “front,” “rear,” “left,” “right,” “top,” “bottom,” “inside,” and “outside” are based on what are illustrated in the drawings. These terms are merely intended to facilitate and simplify the description of the present disclosure, rather than to indicate or imply that the mentioned device or components must have a specific orientation or must be constructed and operated in a specific orientation. Therefore, these terms should not be understood as a limitation to the present disclosure.

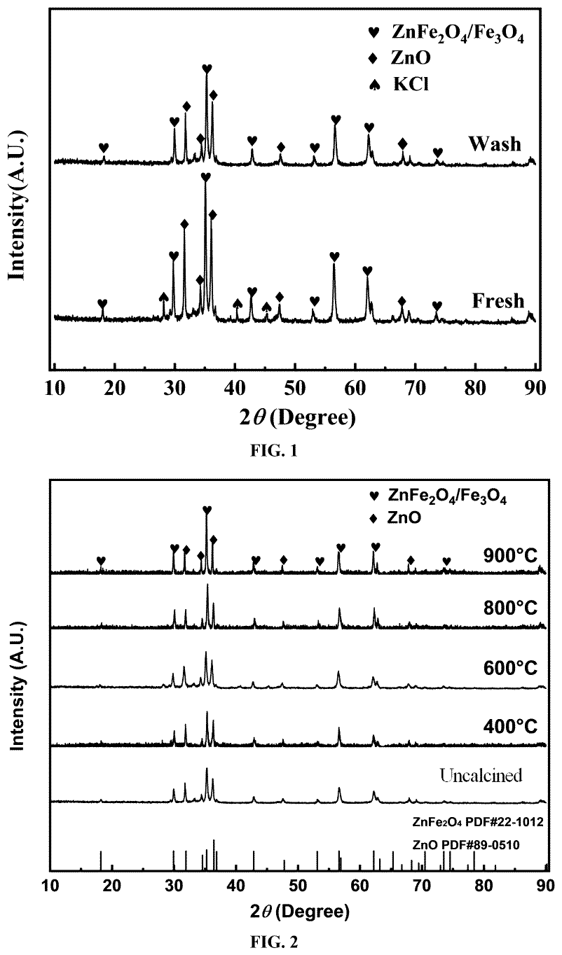

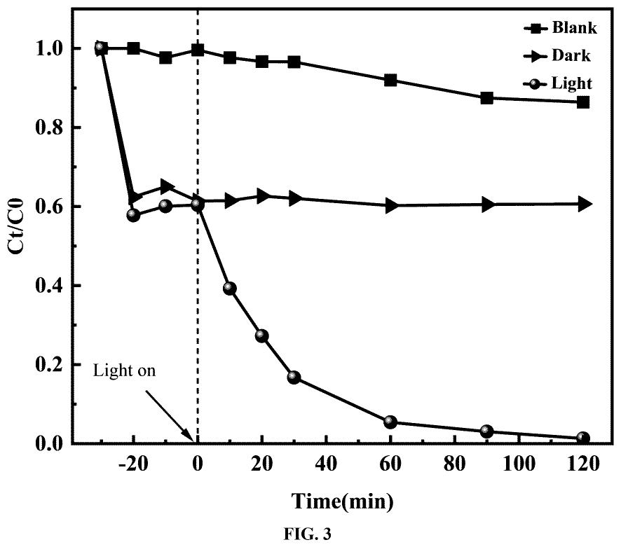

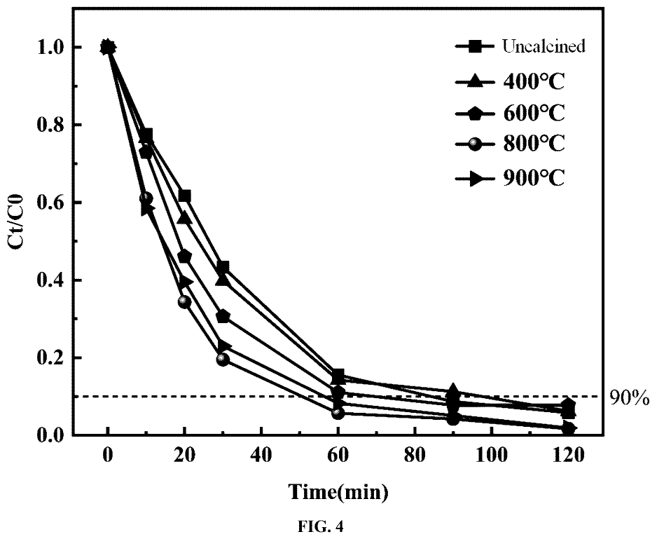

As shown in FIG. 1 to FIG. 4, the present disclosure provides the following technical solutions.

The present disclosure provides a preparation method of a high-efficiency photocatalyst for photocatalytic degradation of tetracycline from EAFD, including the following steps: step 1: collecting EAFD from a steel plant or other industrial processes; mixing the EAFD with deionized water for ultrasonic washing to remove surface impurities and soluble salts; conducting filtration; and pouring an obtained filtered product into an oven, and drying at 80° C. to 100° C. for 3 h to 10 h to obtain solid EAFD; step 2: mixing the solid EAFD obtained in the step 1 with an acid solution (where the acid solution is selected from the group consisting of dilute sulfuric acid and nitric acid), stirring for 1 h to 2 h to remove a part of surface metal oxides and other impurities; and washing with deionized water until neutral, and drying to obtain treated solid EAFD; step 3: mixing the treated solid EAFD obtained in the step 2 with an alkali solution (where the alkali solution is a sodium hydroxide solution), stirring for 1.5 h to 2 h to further modify a surface structure; and washing with deionized water until neutral, and drying to obtain modified solid EAFD; step 4: subjecting the modified solid EAFD to a heat treatment at a high temperature, namely placing the modified solid EAFD into a tubular furnace, introducing O₂ as a carrier gas, and heating to a temperature of 400° C. to 900° C. at a heating rate of 10° C./min and holding the temperature for 2 h; and cooling to room temperature at a cooling rate of 10° C./min to obtain a photocatalyst ZnFe₂O₄@ZnO; and step 5: adding the photocatalyst ZnFe₂O₄@ZnO to a tetracycline solution with a concentration of 30 mg/L, where a dosage of the ZnFe₂O₄@ZnO is 0.1 g/L; after stirring in the dark for 30 min to achieve an adsorption equilibrium, initiating degradation using a 300 W rare-element lamp (where the rare-element lamp includes a xenon lamp and a mercury lamp) as a simulated light source; withdrawing an equal volume of an obtained reaction solution at a time interval of 1 h to 2 h, filtering the reaction solution through a 0.22 μm microporous membrane, transferring an obtained filtrate into a 2 mL high-performance liquid chromatography (HPLC) vial, and observing color and concentration changes of the filtrate.

In the present disclosure, the EAFD and the deionized water are mixed at a solid-to-liquid ratio of 1 g: 80 mL in the step 1.

In the present disclosure, when detecting a degradation effect of the tetracycline, HPLC is conducted to determine a concentration (Ct) of the tetracycline; and an initial concentration of the tetracycline is recorded as C₀, and Cₜ/C₀ represents a ratio of a remaining amount of the tetracycline after the degradation.

### Example 1

The specific steps of the method were as follows:
Step 1: EAFD was collected from a steel plant. The EAFD was mixed with deionized water and subjected to ultrasonic washing to remove surface impurities and soluble salts. The mixture was then filtered. The resulting filtered product was poured into an oven and dried at 80° C. for 3 h, yielding solid EAFD.
Step 2: The EAFD obtained from the step 1 was mixed with an acid solution and stirred for 1 h to remove part of the surface metal oxides and other impurities, and then washed with deionized water until neutral and dried.
Step 3: The EAFD treated in the step 2 was mixed with an alkali solution and stirred for 1.5 h to 2 h to further modify a surface structure. The material was then washed with deionized water until neutral and dried.
Step 4: The modified EAFD underwent a heat treatment at a high temperature, namely the EAFD was placed into a tubular furnace, and O₂ was introduced as a carrier gas. The EAFD was heated to 400° C. at a heating rate of 10° C./min and maintained for 2 h. Subsequently, the EAFD was cooled to room temperature at a cooling rate of 10° C./min, resulting in a photocatalyst ZnFe₂O₄@ZnO.
Step 5: The photocatalyst ZnFe₂O₄@ZnO was added to a tetracycline solution with a concentration of 30 mg/L, using ZnFe₂O₄@ZnO at a dosage of 0.1 g/L. After stirring in the dark for 30 min to achieve an adsorption equilibrium, degradation was initiated under irradiation from a 300 W rare-element lamp serving as a simulated light source. At 1-h time intervals, an equal volume of the reaction solution was withdrawn, filtered through a 0.22 μm microporous membrane, transferred into a 2 mL HPLC vial, and observed for changes in color and concentration.

### Example 2

The specific steps of the method were as follows:
Step 1: EAFD was collected from a steel plant. The EAFD was mixed with deionized water and subjected to ultrasonic washing to remove surface impurities and soluble salts. The mixture was then filtered. The resulting filtered product was poured into an oven and dried at 90° C. for 6.5 h, yielding solid EAFD.
Step 2: The EAFD obtained from the step 1 was mixed with an acid solution and stirred for 1.5 h to remove part of the surface metal oxides and other impurities, and then washed with deionized water until neutral and dried.
Step 3: The EAFD treated in the step 2 was mixed with an alkali solution and stirred for 1.75 h to further modify a surface structure. The material was then washed with deionized water until neutral and dried.
Step 4: The modified EAFD underwent a heat treatment at a high temperature, namely the EAFD was placed into a tubular furnace, and O₂ was introduced as a carrier gas. The EAFD was heated to 800° C. at a heating rate of 10° C./min and maintained for 2 h. Subsequently, the EAFD was cooled to room temperature at a cooling rate of 10° C./min, resulting in a photocatalyst ZnFe₂O₄@ZnO.
Step 5: The photocatalyst ZnFe₂O₄@ZnO was added to a tetracycline solution with a concentration of 30 mg/L, using ZnFe₂O₄@ZnO at a dosage of 0.1 g/L. After stirring in the dark for 30 min to achieve an adsorption equilibrium, degradation was initiated under irradiation from a 300 W rare-element lamp serving as a simulated light source. At 1.5-h time intervals, an equal volume of the reaction solution was withdrawn, filtered through a 0.22 μm microporous membrane, transferred into a 2 mL HPLC vial, and observed for changes in color and concentration.

### Example 3

The specific steps of the method were as follows:
Step 1: EAFD was collected from a steel plant. The EAFD was mixed with deionized water and subjected to ultrasonic washing to remove surface impurities and soluble salts. The mixture was then filtered. The resulting filtered product was poured into an oven and dried at 100° C. for 10 h, yielding solid EAFD.
Step 2: The EAFD obtained from the step 1 was mixed with an acid solution and stirred for 2 h to remove part of the surface metal oxides and other impurities, and then washed with deionized water until neutral and dried.
Step 3: The EAFD treated in the step 2 was mixed with an alkali solution and stirred for 2 h to further modify a surface structure. The material was then washed with deionized water until neutral and dried.
Step 4: The modified EAFD underwent a heat treatment at a high temperature, namely the EAFD was placed into a tubular furnace, and O₂ was introduced as a carrier gas. The EAFD was heated to 900° C. at a heating rate of 10° C./min and maintained for 2 h. Subsequently, the EAFD was cooled to room temperature at a cooling rate of 10° C./min, resulting in a photocatalyst ZnFe₂O₄@ZnO.
Step 5: The photocatalyst ZnFe₂O₄@ZnO was added to a tetracycline solution with a concentration of 30 mg/L, using ZnFe₂O₄@ZnO at a dosage of 0.1 g/L. After stirring in the dark for 30 min to achieve an adsorption equilibrium, degradation was initiated under irradiation from a 300 W rare-element lamp serving as a simulated light source. At 2-h time intervals, an equal volume of the reaction solution was withdrawn, filtered through a 0.22 μm microporous membrane, transferred into a 2 mL HPLC vial, and observed for changes in color and concentration.

The foregoing displays and describes basic principles, main features, and advantages of the present disclosure. Apparently, for a person skilled in the art, the present disclosure is not limited to details of the above examples, and that the present disclosure may be implemented in other specific forms without departing from the spirit or basic features of the present disclosure. Therefore, the examples should be regarded as exemplary and non-limiting in every respect, and the scope of the present disclosure is defined by the appended claims rather than the above description. All changes falling within the meaning and scope of equivalent elements of the claims should be included in the present disclosure, and any reference numbers in the claims should not be construed as a limitation to the involved claims.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

What is claimed is:

1. A preparation method of a high-efficiency photocatalyst for photocatalytic degradation of tetracycline from electric arc furnace dust (EAFD), comprising following steps:
step 1: collecting EAFD from a steel plant or other industrial processes; mixing the EAFD with deionized water for ultrasonic washing to remove surface impurities and soluble salts; conducting filtration; and pouring an obtained filtered product into an oven, and drying at 80° C. to 100° C. for 3 h to 10 h to obtain solid EAFD;
step 2: mixing the solid EAFD obtained in the step 1 with an acid solution, stirring for 1 h to 2 h to remove a part of surface metal oxides and other impurities; and washing with deionized water until neutral, and drying to obtain treated solid EAFD;
step 3: mixing the treated solid EAFD obtained in the step 2 with an alkali solution, stirring for 1.5 h to 2 h to further modify a surface structure; and washing with deionized water until neutral, and drying to obtain modified solid EAFD;
step 4: subjecting the modified solid EAFD to a heat treatment at a high temperature, namely placing the modified solid EAFD into a tubular furnace, introducing O₂ as a carrier gas, and heating to a temperature of 400°C to 900°C at a heating rate of 10° C./min and holding the temperature for 2 h; and cooling to room temperature at a cooling rate of 10° C./min to obtain a photocatalyst ZnFe₂O₄@ZnO; and
step 5: adding the photocatalyst ZnFe₂O₄@ZnO to a tetracycline solution with a concentration of 30 mg/L, wherein a dosage of the ZnFe₂O₄@ZnO is 0.1 g/L; after stirring in the dark for 30 min to achieve an adsorption equilibrium, initiating degradation using a 300 W rare-element lamp as a simulated light source; withdrawing an equal volume of an obtained reaction solution at a time interval of 1 h to 2 h, filtering the reaction solution through a 0.22 μm microporous membrane, transferring an obtained filtrate into a 2 mL high-performance liquid chromatography (HPLC) vial, and observing color and concentration changes of the filtrate.

2. The preparation method of a high-efficiency photocatalyst for photocatalytic degradation of tetracycline from EAFD according to claim 1, wherein the EAFD and the deionized water are mixed at a solid-to-liquid ratio of 1 g: 80 mL in the step 1.

3. The preparation method of a high-efficiency photocatalyst for photocatalytic degradation of tetracycline from EAFD according to claim 1, wherein when detecting a degradation effect of the tetracycline, HPLC is conducted to determine a concentration (Ct) of the tetracycline; and an initial concentration of the tetracycline is recorded as C₀, and Cₜ/C₀ represents a ratio of a remaining amount of the tetracycline after the degradation.

4. The preparation method of a high-efficiency photocatalyst for photocatalytic degradation of tetracycline from EAFD according to claim 1, wherein the rare-element lamp in the step 5 comprises a xenon lamp and a mercury lamp.

5. The preparation method of a high-efficiency photocatalyst for photocatalytic degradation of tetracycline from EAFD according to claim 1, wherein the acid solution in the step 2 is selected from the group consisting of dilute sulfuric acid and nitric acid.

6. The preparation method of a high-efficiency photocatalyst for photocatalytic degradation of tetracycline from EAFD according to claim 1, wherein the alkali solution in the step 3 is a sodium hydroxide solution.
